(19) United States
(12) Patent Application Publication
(10) Pub. No.: US 2025/0379728 A1
(43) Pub. Date: Dec. 11, 2025

(54) METHOD AND SYSTEM FOR SECURE FILE STORAGE AND NON-TRANSITORY COMPUTER READABLE STORAGE MEDIUM

(71) Applicant: QNAP Systems, Inc., New Taipei City (TW)

(72) Inventors: Meng-Ting LU, New Taipei City (TW); Wun-Chih YANG, New Taipei City (TW); Yi-Ru LI, New Taipei City (TW)

(21) Appl. No.: 19/230,760

(22) Filed: Jun. 6, 2025

(30) Foreign Application Priority Data
Jun. 7, 2024 (TW) 113121354

(51) Int. Cl. H04L 9/08; H04L 9/32

(52) U.S. Cl. CPC H04L 9/0863; H04L 9/0825; H04L 9/0894; H04L 9/3247

(57) ABSTRACT

A method and a system for secure file storage are provided, which generate an initial key according to a password inputted by a user, and then generate a code key pair, a signature key pair, and a plaintext file key corresponding to a file. The private keys in the two key pairs are stored after being encrypted with the initial key, the plaintext file key is stored after being encrypted with the public key in the code key pair, and the signature key pair is used to generate and validate the signatures of the user terminal. In addition, the file is stored after being encrypted with the plaintext file key. Therefore, a more secure file storage service is provided based on the aforementioned architecture.

### BACKGROUND

### 1. Technical Field

The present disclosure relates to an information security technology. The present disclosure further relates to a method and a system for secure file storage.

### 2. Description of Related Art

With the development of information technology, more and more companies provide file storage services to meet users' need for file storage and backup. In most of the current file storage services, when a user needs to transfer a file to a third party storage space (server), the user first stores a file key in the account server, and then transfer the file to the third party's server for encryption and storage. When the user needs to read the file, the account server returns the file key to the user, and then the user transfers the file key to the third party's server for decryption and transmission of the file to the user. Since the account server stores the file key, when the account server is attacked by a hacker, there is a risk of leaking the file key, such that the hacker may be able to use the file key to request access to the file data content from the third-party's server.

However, in order to avoid the security problem caused by the leakage of the keys stored in the account servers mentioned above, how to securely protect the file keys in the account servers from being stolen by hackers has become an important technical problem to be solved. The local machine in the present disclosure uses multiple keys and encryption technologies with an interface server and a key server to prevent the leakage of file keys from the account servers (the interface server and the key server) and to prevent leakage of the contents of files stored in the third party's server, so as to further achieve the purpose of file security storage.

### SUMMARY

In order to solve the above-mentioned problem, the present disclosure provides a secure file storage method, which achieves the purpose of protecting contents of files by means of multiple keys and multiple key pairs. The secure file storage method of the present disclosure is performed by a user terminal, an interface server, a key server and a file server. The secure file storage method includes: receiving, by the user terminal, a password provided by a user; using, by the user terminal, the password to cooperate with the interface server to generate an initial key corresponding to the password; using, by the user terminal, a first asymmetric encryption technique to generate a public code key and a private code key; using, by the user terminal, the initial key to encrypt the private code key to generate an encrypted private code key; storing, by the user terminal, the public code key and the encrypted private code key into the key server via the interface server; transmitting, by the user terminal, a first request to the interface server to instruct the interface server to randomly generate a plaintext file key; encrypting, by the interface server, the plaintext file key with the public code key to generate a ciphertext file key; storing, by the interface server, the ciphertext file key into the key server; transmitting, by the interface server, the ciphertext file key to the user terminal; using, by the user terminal, the private code key to decrypt the ciphertext file key to obtain the plaintext file key; using, by the user terminal, a secure protocol to transmit the plaintext file key and a file to the file server; encrypting, by the file server, the file according to the plaintext file key to generate an encrypted file; and storing, by the file server, the encrypted file.

In an embodiment, the user terminal uses an oblivious pseudo random function to cooperate with the interface server to generate the initial key.

In an embodiment, the secure file storage method of the present disclosure further includes: using, by the user terminal, a second asymmetric encryption technique to generate a public signature key and a private signature key; using, by the user terminal, the initial key to encrypt the private signature key to generate an encrypted private signature key; storing, by the user terminal, the public signature key and the encrypted private signature key into the key server via the interface server; and using, by the interface server, the public signature key to verify a signature in the first request.

In an embodiment, the interface server generates the plaintext file key only when the verification of the signature is successful.

In an embodiment, the user terminal deletes the initial key, the private code key and the private signature key after a preset time duration expires.

In an embodiment, the secure file storage method of the present disclosure further includes: obtaining, by the user terminal, the encrypted private code key and the encrypted private signature key from the key server via the interface server; receiving, by the user terminal, the password; cooperating, by the user terminal, with the interface server to generate the initial key; using, by the user terminal, the initial key to decrypt the encrypted private code key to obtain the private code key; and using, by the user terminal, the initial key to decrypt the encrypted private signature key to obtain the private signature key, wherein the initial key, the private code key and the private signature key are used subsequently for encryption context update, file uploading, or file downloading.

In an embodiment, the secure file storage method of the present disclosure further includes: receiving, by the user terminal, a new password; cooperating, by the user terminal, with the interface server to generate a new initial key corresponding to the new password; using, by the user terminal, the new initial key to encrypt the private code key to generate a new encrypted private code key; using, by the user terminal, the new initial key to encrypt the private signature key to generate a new encrypted private signature key; and storing, by the user terminal, the new encrypted private code key and the new encrypted private signature key into the key server via the interface server.

In an embodiment, when the user terminal uses the secure protocol to transmit the plaintext file key and the file to the file server, the user terminal further specifies an encryption algorithm to instruct the file server to use the plaintext file key and the encryption algorithm to encrypt the file to generate the encrypted file.

In an embodiment, the secure file storage method of the present disclosure further includes: transmitting, by the user terminal, a second request to the file server, wherein the second request includes the plaintext file key and specifies the encryption algorithm; using, by the file server, the plaintext file key and the encryption algorithm to decrypt the encrypted file into the file; and transmitting, by the file server, the file to the user terminal.

The present disclosure further provides a secure file storage system, including a user terminal, an interface server, a key server and a file server. The user terminal is configured for receiving a password and cooperating with the interface server to generate an initial key corresponding to the password. The user terminal is further configured for using a first asymmetric encryption technique to generate a public code key and a private code key, and then using the initial key to encrypt the private code key to generate an encrypted private code key, and then storing the public code key and the encrypted private code key into the key server via the interface server. The user terminal is further configured for transmitting a first request to the interface server. The interface server is further configured for randomly generating a plaintext file key in response to the first request, and then using the public code key to encrypt the plaintext file key to generate a ciphertext file key, and then storing the ciphertext file key into the key server and transmitting the ciphertext file key to the user terminal. The user terminal is further configured for using the private code key to decrypt the ciphertext file key to obtain the plaintext file key, and then using a secure protocol to transmit the plaintext file key and a file to the file server. The file server is configured for encrypting the file according to the plaintext file key to generate an encrypted file, and then storing the encrypted file.

The present disclosure uses multiple keys and key pairs to protect contents of files. The keys and key pairs are already encrypted when transmitted and stored, or deleted after use. In this way, the present disclosure is used to achieve more secure storage of files.

### BRIEF DESCRIPTION OF THE DRAWINGS

The present disclosure can be more fully understood by reading the following descriptions of the embodiments, with reference made to the accompanying drawings.

FIG. 1 is a schematic diagram of the architecture of a secure file storage system according to an embodiment of the present disclosure.

FIG. 2 to FIG. 6 are schematic flow diagrams of a secure file storage method according to an embodiment of the present disclosure.

FIG. 7-1 and FIG. 7-2 are schematic flow diagrams of a secure file storage method according to another embodiment of the present disclosure.

### DETAILED DESCRIPTION OF THE EMBODIMENTS

The following examples are used for illustrating the present disclosure. A person skilled in the art can easily conceive the other advantages and effects of the present disclosure, based on the disclosure of the specification. The present disclosure can also be implemented or applied as described in different examples. It is possible to modify or alter the following examples for carrying out the present disclosure without contravening its spirit and scope, for different aspects and applications.

It is further noted that, as used in the present disclosure, the singular forms “a,” “an,” and “the” include plural referents unless expressly and unequivocally limited to one referent. The phrase “and/or” indicates that a plurality of features, elements, or components are to be taken individually, or some of the features, the elements, or the components are to be taken together.

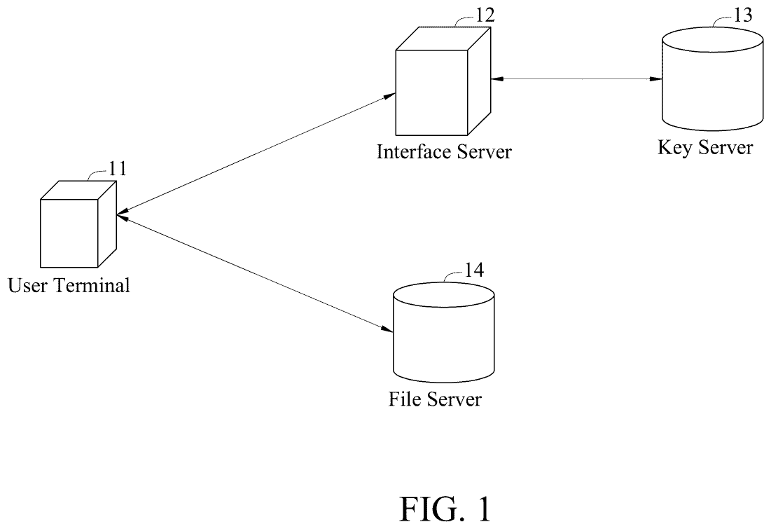

FIG. 1 is a schematic diagram of the architecture of a secure file storage system according to an embodiment of the present disclosure. The secure file storage system includes a user terminal 11, an interface server 12, a key server 13 and a file server 14.

In an embodiment, the user terminal 11 may be an electronic device such as a cell phone or a computer of a user, or an application software installed in the electronic device. The interface server 12 is communicably connected to the user terminal 11 and the key server 13 via a wired or wireless network. The file server 14 is communicably connected to the user terminal 11 via a wired or wireless network.

In an embodiment, the interface server 12, the key server 13 and the file server 14 are three servers that operate separately.

In another embodiment, any two of the interface server 12, the key server 13 and the file server 14 may be incorporated into a single server, while the other one is another server that operates separately.

In another embodiment, the interface server 12, the key server 13 and the file server 14 are incorporated into a single server.

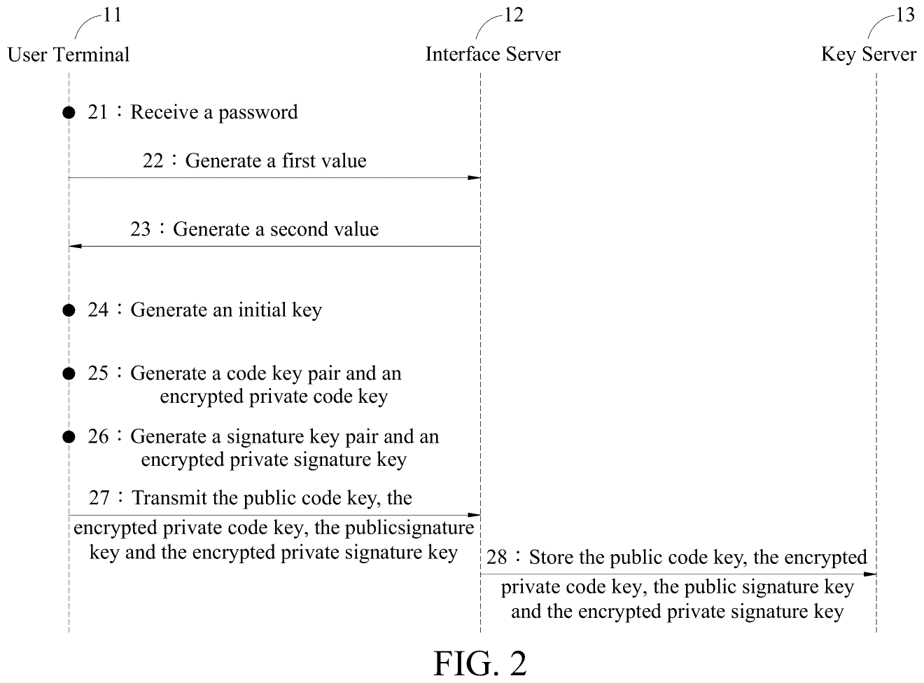

The user terminal 11, the interface server 12, the key server 13 and the file server 14 may be configured to execute the flow of the secure file storage method shown in FIG. 2 to FIG. 6. The following describes the flows shown in FIG. 2 to FIG. 6 one by one.

FIG. 2 shows a schematic flow diagram of encryption context creation in the secure file storage method.

Firstly, at step 21, the user terminal 11 receives a password inputted by a user.

At step 22, the user terminal 11 generates a first value based on an oblivious pseudo random function (OPRF), the password and a random number, and then transmits the first value to the interface server 12.

At step 23, the interface server 12 generates a second value based on the oblivious pseudo random function and the first value, and then transmits the second value to the user terminal 11.

At step 24, the user terminal 11 generates an initial key corresponding to the above-mentioned password based on the oblivious pseudo random function and the second value.

At step 25, the user terminal 11 uses an asymmetric encryption technique to generate a code key pair. The code key pair includes a public code key and a private code key. The user terminal 11 uses the initial key to encrypt the private code key to generate an encrypted private code key.

In an embodiment, the asymmetric encryption technique herein may be the Rivest-Shamir-Adleman (RSA) encryption algorithm, the Advanced Encryption Standard (AES), or another equivalent asymmetric encryption technique.

At step 26, the user terminal 11 uses an asymmetric encryption technique to generate a signature key pair. The signature key pair includes a public signature key and a private signature key. The user terminal 11 uses the initial key to encrypt the private signature key, so as to generate an encrypted private signature key.

In an embodiment, the asymmetric encryption technique herein may be the Rivest-Shamir-Adleman (RSA) encryption algorithm, the Elliptic Curve Digital Signature Algorithm (ECDSA), the Edwards-curve Digital Signature Algorithm (EdDSA), or another equivalent asymmetric encryption technique.

At step 27, the user terminal 11 transmits the public code key, the encrypted private code key, the public signature key and the encrypted private signature key to the interface server 12.

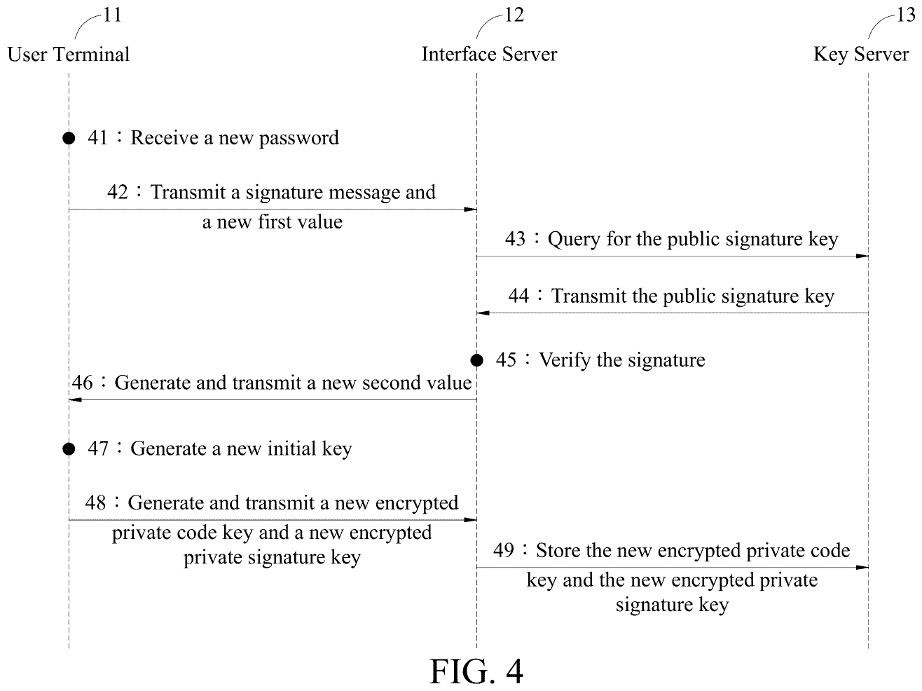

At step 28, the interface server 12 stores the public code key, the encrypted private code key, the public signature key and the encrypted private signature key to the key server 13. The aforementioned four public keys and encrypted private keys may be used in the flows shown in FIG. 4 to FIG. 6.

The user terminal 11 does not store any password or key used in the previous flows for a long time. In other words, after a preset time duration expires, the user terminal 11 deletes all passwords and keys used in previous flows.

If the user terminal 11 needs to execute the flows shown in FIG. 4 to FIG. 6 before the preset time duration expires, the user terminal 11 can directly use the initial key, the private code key and the private signature key that are still stored in the user terminal 11 for the flows shown in FIG. 4 to FIG. 6.

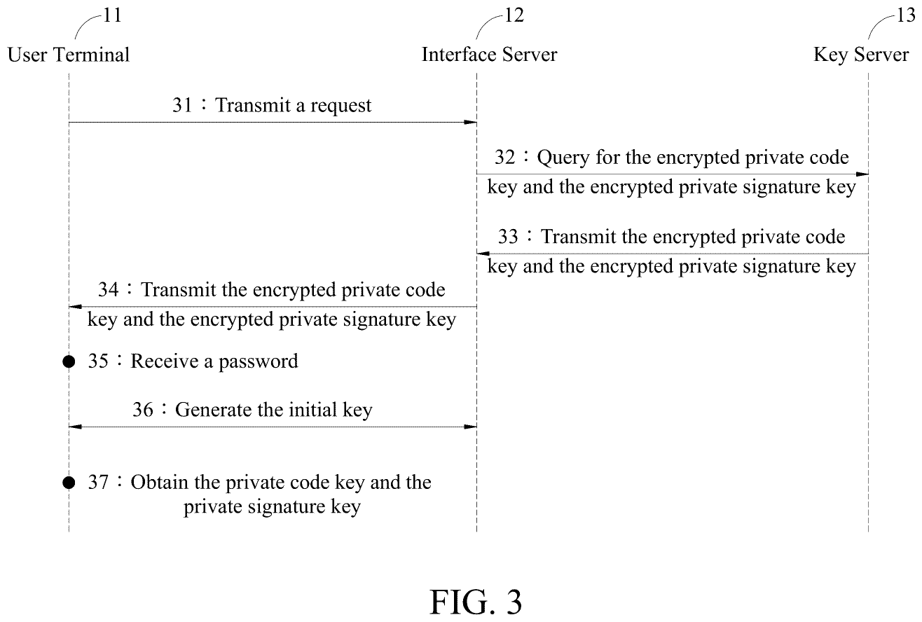

On the contrary, when the initial key, the private code key and the private signature key have been deleted after the preset time duration expires and then the user terminal 11 needs to execute the flows shown in FIG. 4 to FIG. 6, the user terminal 11 has to execute the flow in FIG. 3 first to obtain the initial key, the private code key and the private signature key required for the flows in FIG. 4 to FIG. 6.

FIG. 3 shows a schematic flow diagram of obtaining the encryption context in the above secure file storage method.

Firstly, at step 31, the user terminal 11 transmits a request for obtaining the encryption context to the interface server 12.

At step 32, the interface server 12 responds to the request by querying the key server 13 for the encrypted private code key and the encrypted private signature key of the user terminal 11, i.e., the encrypted private code key and the encrypted private signature key generated in the aforementioned step 25 and step 26.

At step 33, the key server 13 transmits the encrypted private code key and the encrypted private signature key of the user terminal 11 to the interface server 12.

At step 34, the interface server 12 transmits the encrypted private code key and the encrypted private signature key to the user terminal 11.

At step 35, the user terminal 11 receives a password inputted by the user.

At step 36, the user terminal 11 cooperates with the interface server 12 to generate the initial key based on the password. The details of step 36 are the same as those of step 22 to step 24.

At step 37, the user terminal 11 uses the initial key to decrypt the encrypted private code key to obtain the private code key, and the user terminal 11 uses the initial key to decrypt the encrypted private signature key to obtain the private signature key.

The password inputted by the user at step 35 must be the same as the password previously inputted by the user at step 21, so that the initial key generated at step 36 is the same as that generated in the flow of FIG. 2, so that the subsequent steps can be executed correctly.

As described above, after the preset time duration expires, the user terminal 11 deletes the initial key, the private code key and the private signature key obtained previously in the flow of FIG. 3.

After the preset time duration expires, when the user terminal 11 still needs to execute the flows shown in FIG. 4 to FIG. 6, the user terminal 11 has to execute the flow in FIG. 3 again to obtain the initial key, the private code key and the private signature key that are required.

FIG. 4 shows the schematic flow diagram of updating the encryption context in the aforementioned secure file storage method, which is used to handle the change of the password from the user.

Firstly, before the flow in FIG. 4 is executed, the flow in FIG. 2 must be executed to create the encryption context, or the flow in FIG. 3 must be executed to obtain the encryption context that has been created.

Next, at step 41, the user terminal 11 receives a new password inputted by the user.

At step 42, the user terminal 11 transmits a signature message to the interface server 12.

In an embodiment, the signature message includes a new first value generated by the user terminal 11 according to the oblivious pseudo random function, the new password and a random number. The signature message further includes a signature generated by the user terminal 11 based on the private signature key.

At step 43, the interface server 12 responds to the signature message by querying the key server 13 for the public signature key of the user terminal 11.

At step 44, the key server 13 transmits the public signature key of the user terminal 11 to the interface server 12.

At step 45, the interface server 12 uses the public signature key to verify the signature. If the verification of the signature fails, the interface server 12 terminates the flow in FIG. 4. On the contrary, if the verification of the signature is successful, the flow proceeds to step 46.

At step 46, the interface server 12 generates a new second value according to the oblivious pseudo random function and the new first value, and then transmits the new second value to the user terminal 11.

At step 47, the user terminal 11 generates a new initial key corresponding to the new password according to the oblivious pseudo random function and the new second value.

At step 48, the user terminal 11 uses the new initial key to encrypt the private code key to generate a new encrypted private code key, and uses the new initial key to encrypt the private signature key to generate a new encrypted private signature key, and then transmits the new encrypted private code key and the new encrypted private signature key to the interface server 12.

At step 49, the interface server 12 stores the new encrypted private code key and the new encrypted private signature key into the key server 13 to replace the previous encrypted private code key and the previous encrypted private signature key.

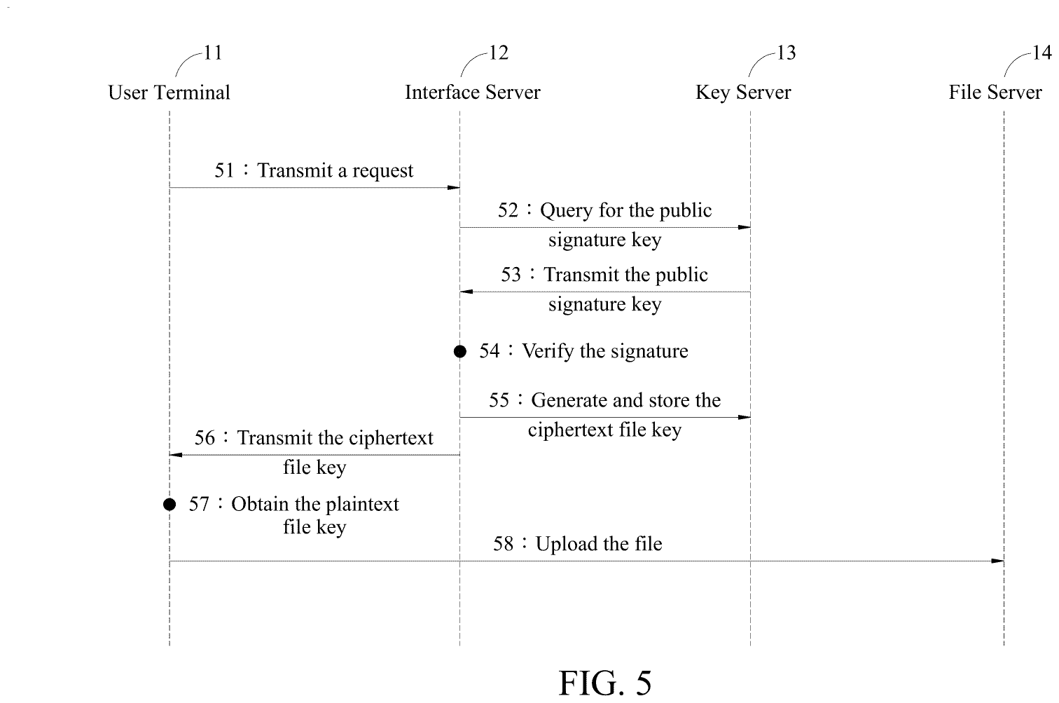

FIG. 5 shows the schematic flow diagram of uploading a file in the aforementioned secure file storage method.

Firstly, before the flow in FIG. 5 is executed, the flow in FIG. 2 must be executed to create the encryption context, or the flow in FIG. 3 must be executed to obtain the encryption context that has been created.

Next, at step 51, the user terminal 11 is about to upload a file to the file server 14. Therefore, the user terminal 11 transmits a request for obtaining the ciphertext file key of the file to the interface server 12.

In an embodiment, the request includes a signature generated by the user terminal 11 based on the private signature key.

At step 52, the interface server 12 responds to the request by querying the key server 13 for the public signature key of the user terminal 11.

At step 53, the key server 13 transmits the public signature key of the user terminal 11 to the interface server 12.

At step 54, the interface server 12 uses the public signature key to verify the signature. If the verification of the signature is successful, the flow proceeds to step 55. If the verification of the signature fails, the interface server 12 rejects the request and terminates the flow of FIG. 5 without generating the plaintext file key as described below.

In other words, the interface server 12 generates the plaintext file key described below only when the verification of the signature is successful.

At step 55, the interface server 12 randomly generates the plaintext file key of the file, and then uses the public code key to encrypt the plaintext file key to generate a ciphertext file key, and then stores the ciphertext file key into the key server 13.

At step 56, the interface server 12 transmits the ciphertext file key to the user terminal 11.

At step 57, the user terminal 11 uses the private code key to decrypt the ciphertext file key to obtain the plaintext file key of the file.

At step 58, the user terminal 11 uses a secure protocol to upload the plaintext file key and the file to the file server 14. In addition, the user terminal 11 specifies an encryption algorithm.

In an embodiment, the sender of the secure protocol encrypts the transmitted data, and the receiver decrypts the received data, wherein the secure protocol may be, for example, Hypertext Transfer Protocol Secure (HTTPS) or another equivalent secure protocol.

Accordingly, the file server 14 uses the plaintext file key and the encryption algorithm to encrypt the file to generate an encrypted file and then stores the encrypted file.

In an embodiment, the encryption algorithm may be the Advanced Encryption Standard (AES) or another equivalent symmetric encryption technique.

In an embodiment, the file server 14 may encrypt the file with the plaintext file key to generate the encrypted file.

In addition, there is a one-to-one correspondence between plaintext file keys and files.

Specifically, when the file server 14 stores multiple files, the interface server 12 generates a different corresponding plaintext file key for each of the files before each of the files is uploaded to the file server 14.

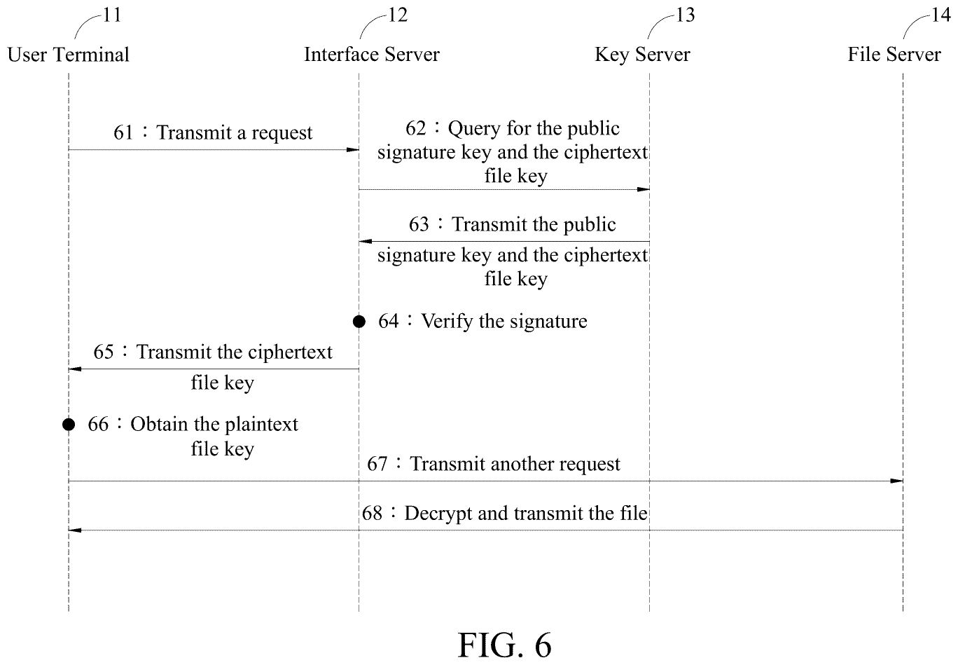

FIG. 6 shows the schematic flow diagram of downloading a file in the aforementioned secure file storage method.

Firstly, before the flow in FIG. 6 is executed, the flow in FIG. 2 must be executed to create the encryption context, or the flow in FIG. 3 must be executed to obtain the encryption context that has been created.

Next, at step 61, the user terminal 11 is about to download a file from the file server 14, and therefore the user terminal 11 transmits a request for obtaining the ciphertext file key of the file to the interface server 12.

In an embodiment, the request includes a signature generated by the user terminal 11 based on the private signature key.

At step 62, the interface server 12 responds to the request by querying the key server 13 for the public signature key of the user terminal 11 and the ciphertext file key of the file.

At step 63, the key server 13 transmits the public signature key of the user terminal 11 and the ciphertext file key of the file to the interface server 12.

At step 64, the interface server 12 uses the public signature key to verify the signature. If the verification of the signature fails, the interface server 12 rejects the request and terminates the flow in FIG. 6. If the verification of the signature is successful, the flow proceeds to step 65.

At step 65, the interface server 12 transmits the ciphertext file key to the user terminal 11.

At step 66, the user terminal 11 uses the private code key to decrypt the ciphertext file key to obtain the plaintext file key of the file.

At step 67, the user terminal 11 uses the aforementioned secure protocol to transmit a request for downloading the file to the file server 14. The request includes the plaintext file key and specifies an encryption algorithm. In addition, the encryption algorithm specified here must be the same as the encryption algorithm specified in step 58.

At step 68, the file server 14 uses the plaintext file key and the encryption algorithm to decrypt the encrypted file (corresponding to the file) into the file, and then uses the aforementioned secure protocol to transmit the file to the user terminal 11.

In an embodiment, the file server 14 may use the plaintext file key to decrypt the encrypted file into the file.

In detail, for the same file, the same plaintext file key of the same file is used at step 58 and step 68, i.e., there is a one-to-one correspondence between plaintext file keys and files. Therefore, the uploaded file is encrypted into the encrypted file according to the plaintext file key at step 58, and the encrypted file is decrypted into the file according to the same plaintext file key at step 68.

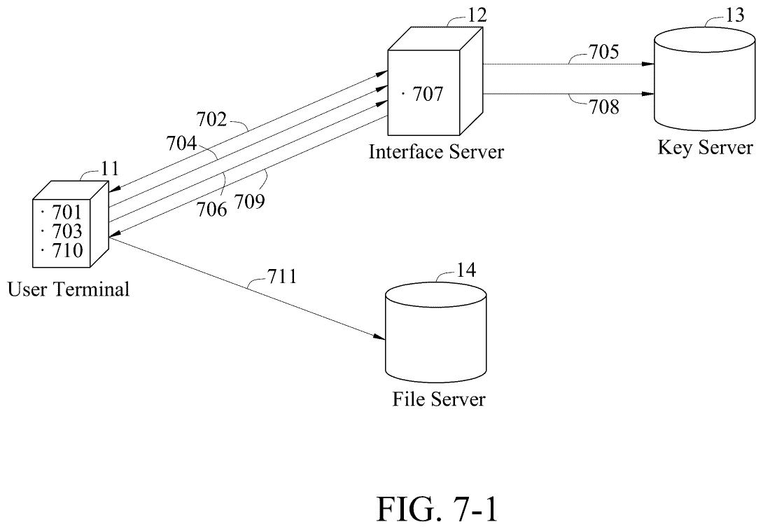

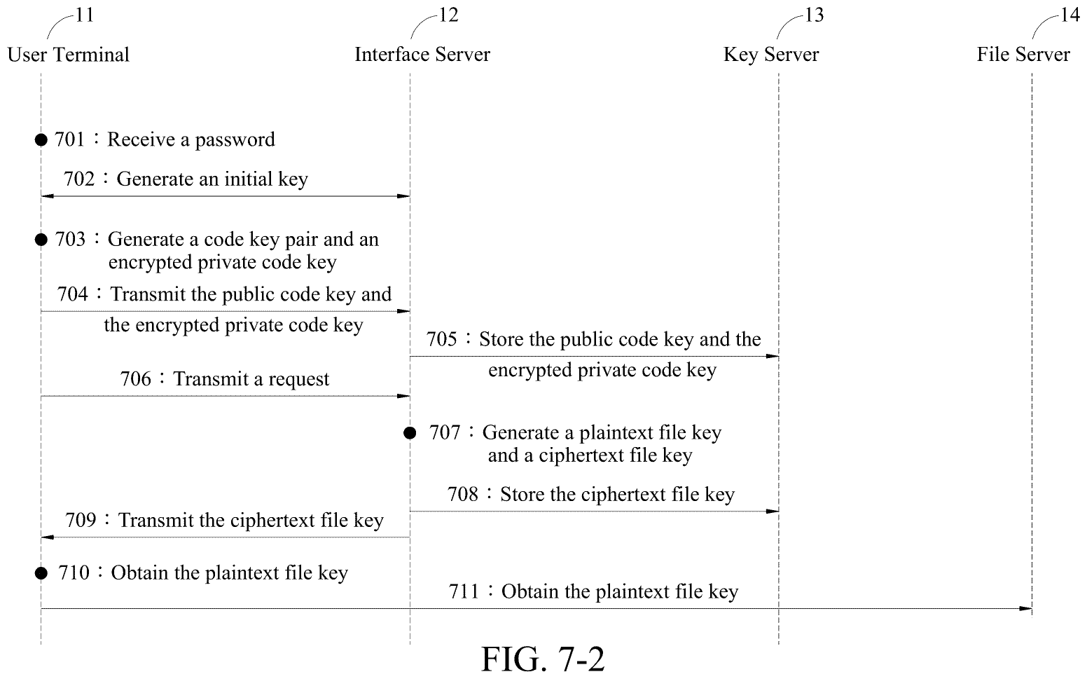

FIG. 7-1 and FIG. 7-2 are schematic flow diagrams of a secure file storage method according to another embodiment of the present disclosure. The flow of the secure file storage method is described below with reference to FIG. 7-1 and FIG. 7-2.

Firstly, at step 701, the user terminal 11 receives a password inputted by a user.

At step 702, the user terminal 11 cooperates with the interface server 12 according to the password to generate an initial key corresponding to the password. The details of step 702 are the same as those of step 22 to step 24.

At step 703, the user terminal 11 uses an asymmetric encryption technique to generate a code key pair. The code key pair includes a public code key and a private code key. In addition, the user terminal 11 uses the initial key to encrypt the private code key to generate an encrypted private code key.

At step 704, the user terminal 11 transmits the public code key and the encrypted private code key to the interface server 12.

At step 705, the interface server 12 stores the public code key and the encrypted private code key into the key server 13.

At step 706, the user terminal 11 is about to upload a file to the file server 14, and therefore transmits a request for obtaining the ciphertext file key of the file to the interface server 12.

At step 707, the interface server 12 randomly generates a plaintext file key and uses the public code key to encrypt the plaintext file key to generate a corresponding ciphertext file key.

At step 708, the interface server 12 stores the ciphertext file key into the key server 13.

At step 709, the interface server 12 transmits the ciphertext file key to the user terminal 11.

At step 710, the user terminal 11 uses the private code key described above to decrypt the ciphertext file key to obtain the plaintext file key of the file.

At step 711, the user terminal 11 uses a secure protocol to upload the plaintext file key and the file to the file server 14. The user terminal 11 further specifies an encryption algorithm. Accordingly, the file server 14 uses the plaintext file key and the encryption algorithm to encrypt the file to generate a corresponding encrypted file, and then stores the encrypted file.

The present disclosure further provides a computer-readable storage medium, such as memory, magnetic tape, magnetic disk, or optical disk. The computer-readable storage medium may be configured to store instructions that can be read by the user terminal, the interface server, the key server and the file server described above to perform the secure file storage method of any one of the embodiments described above. In an embodiment, the computer-readable storage medium is a non-transitory computer-readable storage medium.

In summary, the files of the present disclosure are stored in the file server in encrypted form and are transmitted by the aforementioned secure protocol. In addition, the private code key, the private signature key and the file key described above are stored and transmitted in an encrypted state or transmitted by the aforementioned secure protocol. Furthermore, the password, the first value, the second value and the initial key described above are deleted in the secure file storage system of the present disclosure after use and are not stored for a long period of time. In this way, the present disclosure can provide services such as secure uploading, secure storage and secure downloading of files without the risk of leaking file contents.

While some of the embodiments of the present disclosure have been described in detail above, it is, however, possible for those of ordinary skill in the art to make various modifications and changes to the particular embodiments shown without substantially departing from the teaching and advantages of the present disclosure. Such modifications and changes are encompassed in the spirit and scope of the present disclosure as set forth in the appended claims.

What is claimed is:

1. A secure file storage method, performed by a user terminal, an interface server, a key server and a file server, the secure file storage method comprising:
receiving, by the user terminal, a password;
cooperating, by the user terminal, with the interface server to generate an initial key corresponding to the password;
using, by the user terminal, a first asymmetric encryption technique to generate a public code key and a private code key;
using, by the user terminal, the initial key to encrypt the private code key to generate an encrypted private code key;
using, by the user terminal, a second asymmetric encryption technique to generate a public signature key and a private signature key;
using, by the user terminal, the initial key to encrypt the private signature key to generate an encrypted private signature key;
storing, by the user terminal, the public code key, the encrypted private code key, the public signature key and the encrypted private signature key into the key server via the interface server;
transmitting, by the user terminal, a first request to the interface server to instruct the interface server to verify a signature in the first request by using the public signature key and then to randomly generate a plaintext file key;
encrypting, by the interface server, the plaintext file key with the public code key to generate a ciphertext file key;
storing, by the interface server, the ciphertext file key into the key server;
transmitting, by the interface server, the ciphertext file key to the user terminal;
using, by the user terminal, the private code key to decrypt the ciphertext file key to obtain the plaintext file key;
using, by the user terminal, a secure protocol to transmit the plaintext file key and a file to the file server;
encrypting, by the file server, the file according to the plaintext file key to generate an encrypted file; and
storing, by the file server, the encrypted file.

2. The secure file storage method according to claim 1, wherein the user terminal uses an oblivious pseudo random function to cooperate with the interface server to generate the initial key.

3. The secure file storage method according to claim 1, wherein the interface server generates the plaintext file key only when the verification of the signature is successful.

4. The secure file storage method according to claim 1, wherein the user terminal deletes the initial key, the private code key and the private signature key after a preset time duration expires.

5. The secure file storage method according to claim 4, wherein after the preset time duration expires, the secure file storage method further comprises:
obtaining, by the user terminal, the encrypted private code key and the encrypted private signature key from the key server via the interface server;
receiving, by the user terminal, the password;
cooperating, by the user terminal, with the interface server to generate the initial key;
using, by the user terminal, the initial key to decrypt the encrypted private code key to obtain the private code key; and
using, by the user terminal, the initial key to decrypt the encrypted private signature key to obtain the private signature key, wherein the initial key, the private code key and the private signature key are used subsequently for encryption context update, file uploading, or file downloading.

6. The secure file storage method according to claim 1, further comprising:
receiving, by the user terminal, a new password;
cooperating, by the user terminal, with the interface server to generate a new initial key corresponding to the new password;
using, by the user terminal, the new initial key to encrypt the private code key to generate a new encrypted private code key;
using, by the user terminal, the new initial key to encrypt the private signature key to generate a new encrypted private signature key; and
storing, by the user terminal, the new encrypted private code key and the new encrypted private signature key into the key server via the interface server.

7. The secure file storage method according to claim 1, wherein when the user terminal uses the secure protocol to transmit the plaintext file key and the file to the file server, the user terminal further specifies an encryption algorithm to instruct the file server to use the plaintext file key and the encryption algorithm to encrypt the file to generate the encrypted file.

8. The secure file storage method according to claim 7, further comprising:
transmitting, by the user terminal, a second request to the file server, wherein the second request comprises the plaintext file key and specifies the encryption algorithm;
using, by the file server, the plaintext file key and the encryption algorithm to decrypt the encrypted file into the file; and
transmitting, by the file server, the file to the user terminal.

9. A secure file storage system, comprising a user terminal, an interface server, a key server and a file server for executing a secure file storage method, wherein the secure file storage method comprises:
receiving, by the user terminal, a password;
cooperating, by the user terminal, with the interface server to generate an initial key corresponding to the password;
using, by the user terminal, a first asymmetric encryption technique to generate a public code key and a private code key;
using, by the user terminal, the initial key to encrypt the private code key to generate an encrypted private code key;
using, by the user terminal, a second asymmetric encryption technique to generate a public signature key and a private signature key;
using, by the user terminal, the initial key to encrypt the private signature key to generate an encrypted private signature key;
storing, by the user terminal, the public code key, the encrypted private code key, the public signature key and the encrypted private signature key into the key server via the interface server;
transmitting, by the user terminal, a first request to the interface server to instruct the interface server to verify a signature in the first request by using the public signature key and then to randomly generate a plaintext file key;
encrypting, by the interface server, the plaintext file key with the public code key to generate a ciphertext file key;
storing, by the interface server, the ciphertext file key into the key server;
transmitting, by the interface server, the ciphertext file key to the user terminal;
using, by the user terminal, the private code key to decrypt the ciphertext file key to obtain the plaintext file key;
using, by the user terminal, a secure protocol to transmit the plaintext file key and a file to the file server;
encrypting, by the file server, the file according to the plaintext file key to generate an encrypted file; and
storing, by the file server, the encrypted file.

10. A non-transitory computer readable storage medium, storing instructions therein, to execute a secure file storage method, performed by a user terminal, an interface server, a key server and a file server, the secure file storage method comprising:
receiving, by the user terminal, a password;
cooperating, by the user terminal, with the interface server to generate an initial key corresponding to the password;
using, by the user terminal, a first asymmetric encryption technique to generate a public code key and a private code key;
using, by the user terminal, the initial key to encrypt the private code key to generate an encrypted private code key;
using, by the user terminal, a second asymmetric encryption technique to generate a public signature key and a private signature key;
using, by the user terminal, the initial key to encrypt the private signature key to generate an encrypted private signature key;
storing, by the user terminal, the public code key, the encrypted private code key, the public signature key and the encrypted private signature key into the key server via the interface server;
transmitting, by the user terminal, a first request to the interface server to instruct the interface server to verify a signature in the first request by using the public signature key and then to randomly generate a plaintext file key;
encrypting, by the interface server, the plaintext file key with the public code key to generate a ciphertext file key;
storing, by the interface server, the ciphertext file key into the key server;
transmitting, by the interface server, the ciphertext file key to the user terminal;
using, by the user terminal, the private code key to decrypt the ciphertext file key to obtain the plaintext file key;
using, by the user terminal, a secure protocol to transmit the plaintext file key and a file to the file server;
encrypting, by the file server, the file according to the plaintext file key to generate an encrypted file; and
storing, by the file server, the encrypted file.
